(19) United States
(12) Patent Application Publication
(10) Pub. No.: US 2025/0038497 A1
(43) Pub. Date: Jan. 30, 2025

(54) WIRE HARNESS AND METHOD FOR MANUFACTURING WIRE HARNESS

(71) Applicant: YAZAKI CORPORATION, Tokyo (JP)

(72) Inventor: Kazuki Yamamoto, Makinohara-shi (JP)

(21) Appl. No.: 18/759,695

(22) Filed: Jun. 28, 2024

(30) Foreign Application Priority Data
Jul. 27, 2023 (JP) 2023-122125

(51) Int. Cl. H02G 3/04

(52) U.S. Cl. CPC H02G 3/0462

(57) ABSTRACT

A wire harness includes: a plurality of wiring members having conductivity; a molded member that is an exterior member for the wiring members provided integrally with the plurality of wiring members by covering the plurality of wiring members; and a winding tape bundling the plurality of wiring members disposed inside the molded member. Therefore, at the time of attaching the molded member for covering the plurality of wiring members to the wiring members by forming the molded member using the mold, it is possible to attach the molded member to the wiring members while maintaining the plurality of wiring members in the bundled state.

### CROSS-REFERENCE TO RELATED APPLICATION(S)

The present application claims priority to and incorporates by reference the entire contents of Japanese Patent Application No. 2023-122125 filed in Japan on Jul. 27, 2023.

### BACKGROUND OF THE INVENTION

### 1. Field of the Invention

The present invention relates to a wire harness and a method for manufacturing a wire harness.

### 2. Description of the Related Art

In a wire harness, an exterior material is indispensable to protect an electric wire from an exterior structure such as an iron plate of a vehicle. In conventional wire harnesses, various types of exterior materials are used for protecting electric wires. For example, a wire harness described in Japanese Patent Application Laid-open No. 2019-160568 includes an electric wire bundle and a molded body integrally provided in an attachment portion which is a part of the electric wire bundle in an axial direction, and the molded body is made of a thermoplastic resin.

However, in the conventional wire harnesses, since various types of exterior members are used, there are many exterior members that are difficult to attach to electric wires without manual labor. That is, in some of the various types of exterior members, a wiring member such as an electric wire may come loose when the exterior member is attached to the wiring member, and in a certain case, a part of the loose wiring member may stick out of the exterior member. Therefore, some conventional wire harnesses need to manually adjust the arrangement of the wiring member with respect to the exterior member when attaching the exterior member, and there is room for improvement from the viewpoint of the attachment of the exterior member to the wiring member.

### SUMMARY OF THE INVENTION

The present invention has been made in view of the above, and an object of the present invention is to provide a wire harness and a method for manufacturing a wire harness capable of suppressing a wiring member from being loose when attaching an exterior member to the wiring member and suppressing the wiring member from sticking out of the exterior member.

A wire harness according to one aspect of the present invention includes a plurality of wiring members having conductivity; a molded member provided integrally with the plurality of wiring members by covering the plurality of wiring members; and a winding tape bundling the plurality of wiring members disposed inside the molded member.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic view of a wire harness according to a first embodiment;

FIG. 2 is a schematic view illustrating a state in which a winding tape is wound around a plurality of wiring members;

FIG. 3 is a cross-sectional view of a mold in a state in which the wiring members illustrated in FIG. 2 are disposed in the mold;

FIG. 4 is a schematic view illustrating a state in which the mold illustrated in FIG. 3 is filled with a resin material;

FIG. 5 is a schematic view illustrating a state in which a plurality of wiring members pass inside a molding portion of the mold without winding a winding tape around the wiring members;

FIG. 6 is a schematic view of a wire harness with a molded member formed without winding a winding tape around a plurality of wiring members;

FIG. 7 is a schematic diagram of a wire harness according to a second embodiment;

FIG. 8 is a schematic view illustrating a state in which winding tapes are wound around a plurality of wiring members in the second embodiment;

FIG. 9 is an explanatory view illustrating a state in which the wiring members illustrated in FIG. 8 are disposed in a mold;

FIG. 10 is an explanatory view illustrating a state in which a plurality of wiring members are disposed in the mold without winding a winding tape around the wiring members; and

FIG. 11 is a schematic view of a wire harness with a molded member formed without winding a winding tape around a plurality of wiring members.

### DETAILED DESCRIPTION OF THE PREFERRED EMBODIMENTS

Hereinafter, an embodiment according to the present invention will be described in detail with reference to the drawings. Note that the present invention is not limited by the present embodiment. In addition, the components in the following embodiment include those that can be easily replaced by those skilled in the art or those that are substantially the same.

### First Embodiment

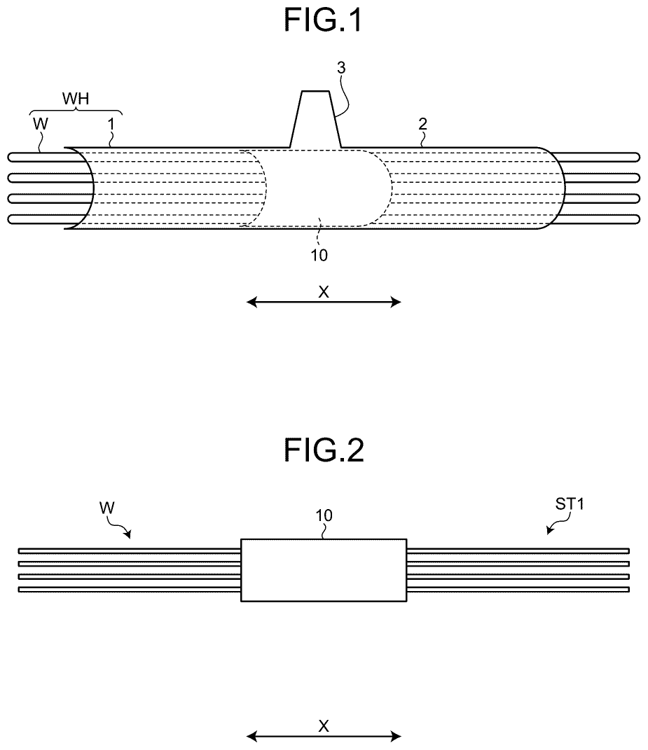

FIG. 1 is a schematic diagram of a wire harness WH according to a first embodiment. The wire harness WH according to the first embodiment is wired in a vehicle or the like. For example, the wire harness WH is, for example, a collective component in which a plurality of wiring members W used for power supply and signal communication are bundled to connect devices mounted on the vehicle to each other, and the plurality of wiring members W are connected to the respective devices by connectors or the like. The wire harness WH includes a plurality of wiring members W having conductivity, and a molded member 1 provided as one body around the plurality of wiring members W to bundle the plurality of wiring members W. The wire harness WH may further include various components such as a corrugated tube, a resin tape, an exterior member such as a protector, an electrical connection box, and a fixing tool.

The wiring member W is formed of, for example, a metal rod, an electric wire, an electric wire bundle, or the like. The metal rod is a rod-shaped member having conductivity. The electric wire is a conductor (core wire) made of a plurality of conductive metal element wires. The electric wire bundle is a bundle of electric wires. Note that each of the wiring members W may be covered with an insulating coating.

The molded member 1 is provided as an exterior member for the wiring members W. The molded member 1 is provided around the plurality of wiring members W to cover the plurality of wiring members W in such a manner as to bundle the plurality of wiring members W along a predetermined direction (hereinafter, referred to as an extending direction X) in which the plurality of wiring members W extend. The molded member 1 is formed of, for example, an insulating elastic resin material (e.g., an ethylene-propylene-diene rubber (EPDM) or the like) having low rigidity and high flexibility, such as a rubber or a thermoplastic elastomer. The molded member 1 is provided around the plurality of wiring members W by molding the elastic resin material as one body to bundle the plurality of wiring members W. Therefore, the wire harness WH can have flexibility together with the molded member 1. The molded member 1 collectively covers some sections of the plurality of wiring members W, and the sections of the plurality of wiring members W are embedded. Note that the coating constituting the wiring member W is typically an insulating coating member provided over the entire length of the wiring member W, whereas the molded member 1 is a protective member partially provided at a necessary portion of the wiring member W to protect the wiring member W, regulate the route of the wiring member W, and the like outside the coating member.

In the first embodiment, the molded member 1 is formed in a substantially columnar shape in which the axial direction is a direction along the extending direction X of the wiring members W. The plurality of wiring members W are arranged around the axis of the cylinder, which is the shape of the molded member 1, inside the molded member 1.

In the molded member 1 according to the first embodiment, a protrusion 3, which is a gate portion when the molded member 1 is formed by injection molding, protrudes from an outer surface 2 of the molded member 1 and is formed on a part of the outer surface 2. That is, the protrusion 3 formed on the outer surface 2 of the molded member 1 is a mark of n portion of the resin material injected into a mold 20 when the molded member 1 is injection-molded using the mold 20 (see FIG. 4). The protrusion 3 is formed on the outer surface 2 near the center of the molded member 1 in the extending direction X of the wiring members W.

The plurality of wiring members W disposed inside the molded member 1 are bundled by a winding tape 10. The winding tape 10 is disposed inside the molded member 1 together with the wiring members W, and is wound around the plurality of wiring members W in a lump to bundle the plurality of wiring members W. The winding tape 10 has a width in the extending direction X of the wiring members W narrower than a length of the molded member 1 in the extending direction X of the wiring members W. Therefore, the winding tape 10 is wound at a position of a part of a section of the wiring member W located inside the molded member 1.

In the first embodiment, the winding tape 10 that bundles the plurality of wiring members W inside the molded member 1 is disposed to include the same position as the position where the protrusion 3, which is a gate portion of the molded member 1, is formed in the extending direction X of the wiring members W. That is, the winding tape 10 is disposed at a position overlapping the protrusion 3 in the radial direction of the cylinder that is the shape of the molded member 1.

Next, a method for manufacturing the wire harness WH according to the first embodiment will be described. FIG. 2 is a schematic view illustrating a state in which a winding tape 10 is wound around a plurality of wiring members W. FIG. 2 illustrates a step (ST1) of bundling a plurality of conductive wiring members W and winding a winding tape 10. When manufacturing a wire harness WH according to the first embodiment, first, a plurality of wiring members W are bundled, and a winding tape 10 is wound around the plurality of wiring members W as illustrated in FIG. 2. The winding tape 10 is a so-called adhesive tape, and can maintain the plurality of wiring members W in a bundled state by winding the winding tape 10 around the wiring members W in a state where the plurality of wiring members W are bundled.

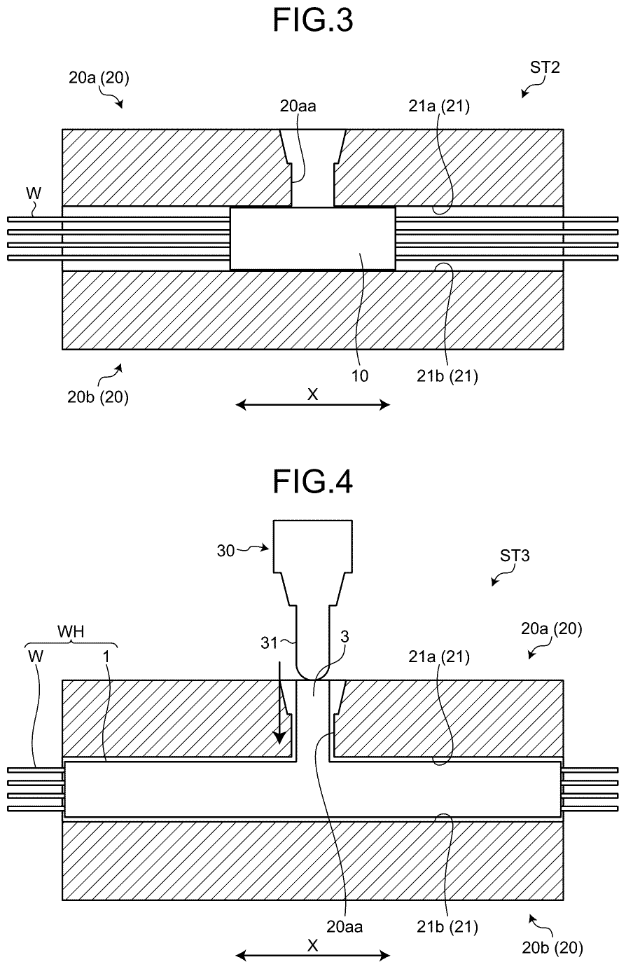

FIG. 3 is a cross-sectional view of a mold 20 in a state where the wiring members W illustrated in FIG. 2 are disposed in the mold 20. FIG. 3 illustrates a step (ST2) of providing the plurality of wiring members W in a mold 20. After the winding tape 10 is wound around the wiring members W in a state where the plurality of wiring members W are bundled, a molded member 1 is provided by injection-molding a resin material around the plurality of wiring members W around which the winding tape 10 is wound. The injection molding for forming the molded member 1 is performed using a mold 20 capable of forming a molded member 1. Therefore, after the winding tape 10 is wound around the plurality of wiring members W, the wiring members W are disposed in the mold 20 for forming a molded member 1. In the first embodiment, the mold 20 includes an upper mold 20a and a lower mold 20b, and molding for forming a molded member 1 is performed in a state where the upper mold 20a and the lower mold 20b are laid on each other in the vertical direction. That is, the upper mold 20a is laid on the lower mold 20b from above.

A molding portion 21 for forming a molded member 1 is formed on surfaces facing each other of the upper mold 20a and the lower mold 20b. Specifically, a first molding portion 21a constituting the molding portion 21 is formed on a surface of the upper mold 20a on a side facing the lower mold 20b, and a second molding portion 21b constituting the molding portion 21 is formed on a surface of the lower mold 20b on a side facing the upper mold 20a. The first molding portion 21a and the second molding portion 21b are formed in shapes capable of forming an outer surface 2 of a molded member 1. Each of the first molding portion 21a and the second molding portion 21b is formed in a shape capable of forming an outer surface 2 in a range of about 180° in a circumferential direction of a cylinder that is a shape of a molded member 1.

In the upper mold 20a, an insertion hole 20aa that is a hole for inserting a nozzle 31 (see FIG. 4) of an injection device 30 (see FIG. 4) when the resin material is injected into the mold 20 to form a molded member 1. The insertion hole 20aa is formed as a hole communicating with the first molding portion 21a from a surface of the upper mold 20a opposite to the surface facing the lower mold 20b.

When a molded member 1 is formed using the mold 20, the upper mold 20a and the lower mold 20b are laid on each other in a state where the wiring members W pass inside the first molding portion 21a of the upper mold 20a and the second molding portion 21b of the lower mold 20b. At this time, the wiring members W are disposed at a position where the winding tape 10 wound around the wiring members W overlaps the insertion hole 20aa formed in the upper mold 20a. That is, the wiring members W are disposed inside the molding portion 21 formed in the mold 20 to include a portion where the position of the winding tape 10 in the extending direction X of the wiring members W is the same as the position of the insertion hole 20aa formed in the upper mold 20a.

FIG. 4 is a schematic view illustrating a state in which the mold 20 illustrated in FIG. 3 is filled with a resin material. FIG. 4 illustrates a step (ST3) of providing a molded member 1 by injection molding around the plurality of wiring members W around which the winding tape 10 is wound. After the plurality of wiring members W bundled by winding the winding tape 10 pass inside the molding portion 21 formed in the mold 20, the molding portion 21 is filled with a melted resin material in a state where the upper mold 20a and the lower mold 20b are laid on each other. The resin material is filled into the molding portion 21 using the injection device 30. The injection device 30 is capable of melting the resin material, and is capable of injecting the melted resin material from the nozzle 31.

When the resin material is filled into the molding portion 21 of the mold 20, the nozzle 31 of the injection device 30 is inserted into the insertion hole 20aa formed in the upper mold 20a, and the melted resin material is injected from the nozzle 31 to inject the resin material into the molding portion 21. As a result, a space formed by the first molding portion 21a of the upper mold 20a and the second molding portion 21b of the lower mold 20b is filled with the resin material.

The resin material filled in the molding portion 21 is cooled and hardened over time. As a result, the resin material is formed as a molded member 1 covering the wiring members W disposed inside. After the resin material in the molding portion 21 is hardened and the resin material is formed as the molded member 1, the upper mold 20a and the lower mold 20b are separated from each other to take out the molded member 1 formed by the mold 20.

Here, in the first embodiment, the plurality of wiring members W are bundled by the winding tape 10 before the molded member 1 is formed by the mold 20 with the wiring members W passing inside the molding portion 21 of the mold 20. That is, when the molded member 1 is formed by the molding portion 21 of the mold 20, molding is performed in a state where the wiring members W bundled by the winding tape 10 pass inside the molding portion 21. Therefore, the molded member 1 is formed in a state where the plurality of wiring members W passing inside the molding portion 21 are not loose.

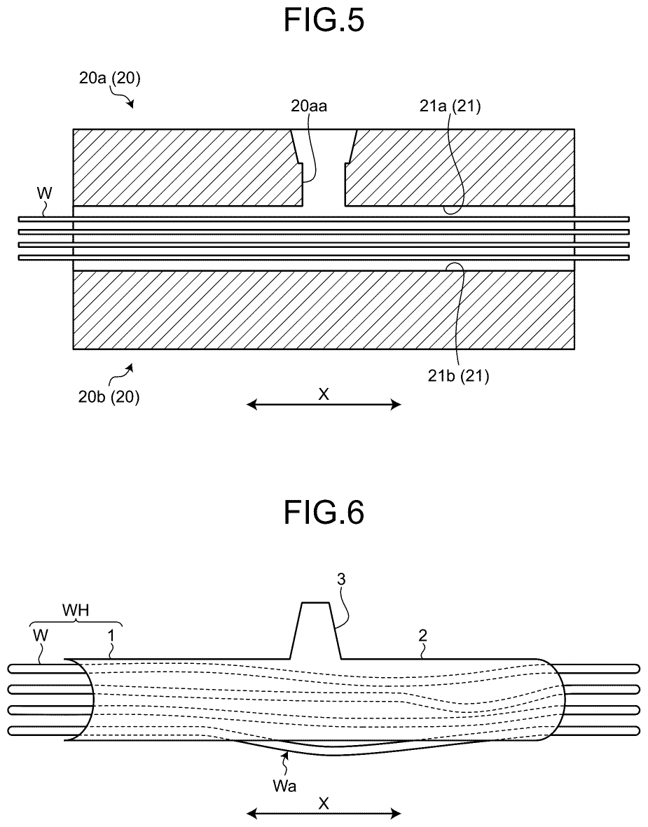

FIG. 5 is a schematic view illustrating a state in which a plurality of wiring members W pass inside the molding portion 21 of the mold 20 without winding a winding tape 10 around the wiring members W. FIG. 6 is a schematic view of a wire harness WH with a molded member 1 formed without winding a winding tape 10 around a plurality of wiring members W. When the molded member 1 of the wire harness WH is formed using the mold 20, for example, if the winding tape 10 is not wound around the plurality of wiring members W as illustrated in FIG. 5, there is a possibility that the wiring members W may be loose. That is, the resin material injected into the molding portion 21 of the mold 20 to form a molded member 1 is filled in the molding portion 21 while flowing in the molding portion 21. Therefore, the pressure acts on the wiring members W disposed inside the molding portion 21 of the mold 20 when the resin material flows in the molding portion 21, and the plurality of wiring members W may be loose by the pressure from the resin material.

When the resin material in the molding portion 21 is hardened in a state where the wiring members W in the molding portion 21 of the mold 20 are loose, there is a possibility that some of the plurality of wiring members W may be hardened in a state where they stick out of the molded member 1. That is, when the resin material in the molding portion 21 is hardened in a state where the wiring members W are loose, if the resin material is hardened in a state where some of the wiring members W stick of the resin material, there is a possibility that some of the wiring members W may have a stick-out portion Wa that is a part of the wiring member W sticks of the molded member 1 in the wire harness WH as illustrated in FIG. 6. In this case, the molded member 1 cannot protect the stick-out portion Wa of the wiring member W that sticks out of the molded member 1.

On the other hand, in the wire harness WH according to the first embodiment, since the molded member 1 is formed in a state where the plurality of wiring members W are bundled by the winding tape 10, the molded member 1 can be formed with none of the wiring members W sticking out of the molded member 1. As a result, the wire harness WH can appropriately protect the wiring members W through the molded member 1.

In this way, in the wire harness WH, a part of each of the plurality of wiring members W is covered with the molded member 1, and the plurality of wiring members W are wired to certain positions in a state where the wiring members W are protected by the molded member 1. At this time, since the protrusion 3 is formed on the molded member 1, positioning can be performed based on the protrusion 3 when the molded member 1 is disposed at a certain position. Accordingly, when the wire harness WH is wired, the molded member 1 can be disposed at an appropriate position.

In the wire harness WH according to the above-described embodiment, the wiring members W disposed inside the molded member 1 are disposed inside the molded member 1 in a state where the winding tape 10 is wound around the plurality of wiring members W and the plurality of wiring members W are bundled by the winding tape 10. Therefore, at the time of attaching the molded member 1 for covering the plurality of wiring members W to the wiring members W by forming the molded member 1 using the mold 20, it is possible to attach the molded member 1 to the wiring members W while maintaining the plurality of wiring members W in the bundled state. As a result, it is possible to suppress the wiring members W from being loose when the molded member 1, which is an exterior member, is attached to the wiring members W, and it is possible to suppress the wiring members W from sticking out of the molded member 1. In addition, since the wiring members W can be suppressed from sticking of the molded member 1, the wire harness WH can be manufactured with constant quality.

In addition, since the winding tape 10 is disposed to include the same position as the position where the protrusion 3, which is a gate portion of the molded member 1, is formed in the extending direction X of the wiring members W, it is possible to further suppress the wiring members W from being loose. That is, when the molded member 1 is formed using the mold 20, a melted resin material is injected into the molding portion 21 of the mold 20 from the position of the insertion hole 20aa formed in the mold 20. For this reason, the pressure from the resin material when the resin material is injected into the molding portion 21 easily acts as a large pressure on the wiring members W arranged in the molding portion 21 of the mold 20 at the time of forming the molded member 1 at portions of the wiring members W located in the vicinity of the insertion hole 20aa. As a result, the portions of the wiring members W located in the vicinity of the insertion hole 20aa are likely to be loose by the large pressure acting from the resin material at the time of forming of the molded member 1.

On the other hand, in the wire harness WH according to the first embodiment, the winding tape 10 that bundles the plurality of wiring members W is disposed around the wiring members W to include the same position as the position where the protrusion 3, which is a gate portion of the molded member 1, is formed in the extending direction X of the wiring members W. That is, the winding tape 10 is disposed to include a portion where the insertion hole 20aa of the mold 20, which is a portion where the resin material is injected at the time of forming the molded member 1, is positioned in the extending direction X of the wiring members W. For this reason, the plurality of wiring members W can be bundled by the winding tape 10 at a portion where the wiring members W are likely to be loose due to a large pressure that easily acts from the resin material at the time of forming the molded member 1.

As a result, by bundling the wiring members W with the winding tape 10 at a portion where the wiring members W are likely to be loose due to a large pressure that easily acts from the resin material at the time of forming the molded member 1, the plurality of wiring members W can be maintained in a bundled state even at the time of forming the molded member 1. As a result, it is possible to suppress the wiring members W from being loose when the molded member 1 is attached to the wiring members W, and it is possible to suppress the wiring members W from sticking out of the molded member 1.

In a method for manufacturing a wire harness WH according to the first embodiment, a plurality of conductive wiring members W are bundled and a winding tape 10 is wound around the wiring members W, and a molded member 1 is provided around the plurality of wiring members W around which the winding tape 10 is wound by injection molding. As a result, when the molded member 1 is provided around the plurality of wiring members W, the molded member 1 can be provided while maintaining the bundled state of the plurality of wiring members W, and the molded member 1 can be attached to the wiring members W while maintaining the bundled state of the plurality of wiring members W. As a result, it is possible to suppress the wiring members W from being loose when the molded member 1, which is an exterior member, is attached to the wiring members W, and it is possible to suppress the wiring members W from sticking out of the molded member 1.

### Second Embodiment

A wire harness WH according to a second embodiment has substantially the same configurations as the wire harness WH according to the first embodiment, but is characterized in that the winding tape 10 that bundles the wiring members W is disposed to include a position of an end 5 of the molded member 1. Since the other configurations are similar to those of the first embodiment, the description thereof is omitted and the same reference numerals are given.

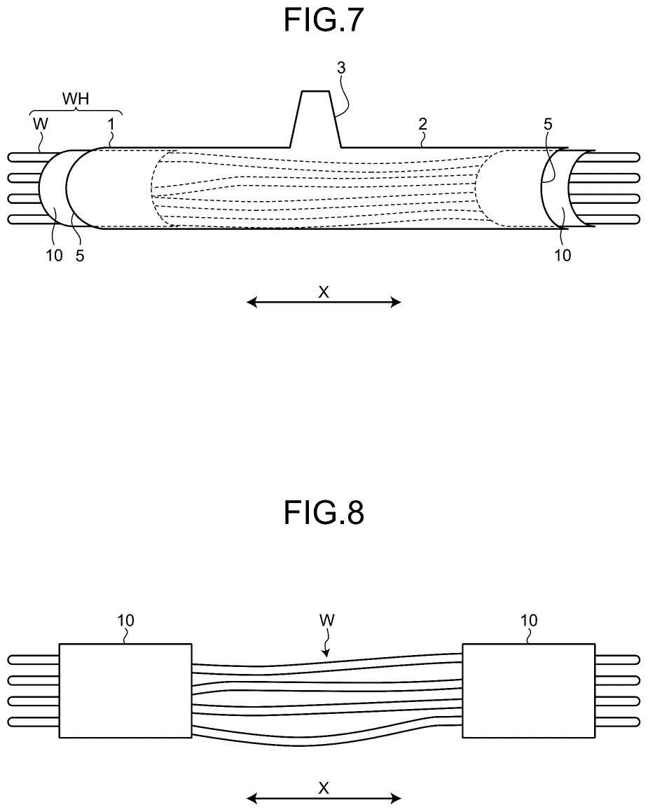

FIG. 7 is a schematic diagram of a wire harness WH according to the second embodiment. Similarly to the wire harness WH according to the first embodiment, the wire harness WH according to the second embodiment includes a molded member 1 that covers conductive wiring members W, and the molded member 1 is provided integrally with the wiring member W to cover the plurality of wiring members W. A winding tape 10 is wound around the plurality of wiring members W, and the plurality of wiring members W are bundled by the winding tape 10.

Unlike the first embodiment, the winding tape 10 that bundles the plurality of wiring members W is disposed to include the position of the end 5 of the molded member 1 in the extending direction X of the wiring members W. That is, winding tapes 10 are disposed at positions overlapping both ends 5 in the extending direction X of the wiring members W of the molded member 1 in the radial direction of the cylinder that is the shape of the molded member 1. That is, the winding tape 10 is disposed at one location near the center of the molded member 1 in the extending direction X of the wiring members W in the first embodiment, whereas the winding tapes 10 are disposed at two portions near both ends of the molded member 1 in the extending direction X of the wiring members W in the second embodiment.

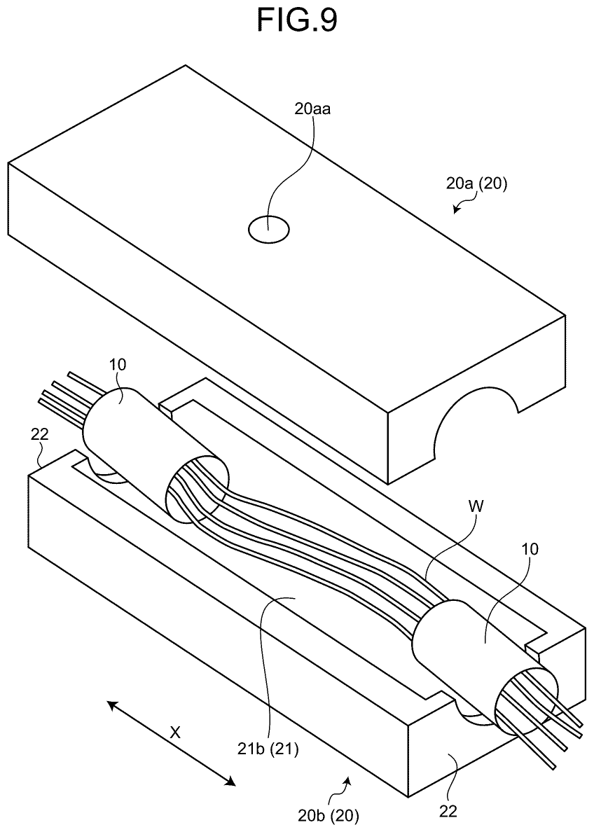

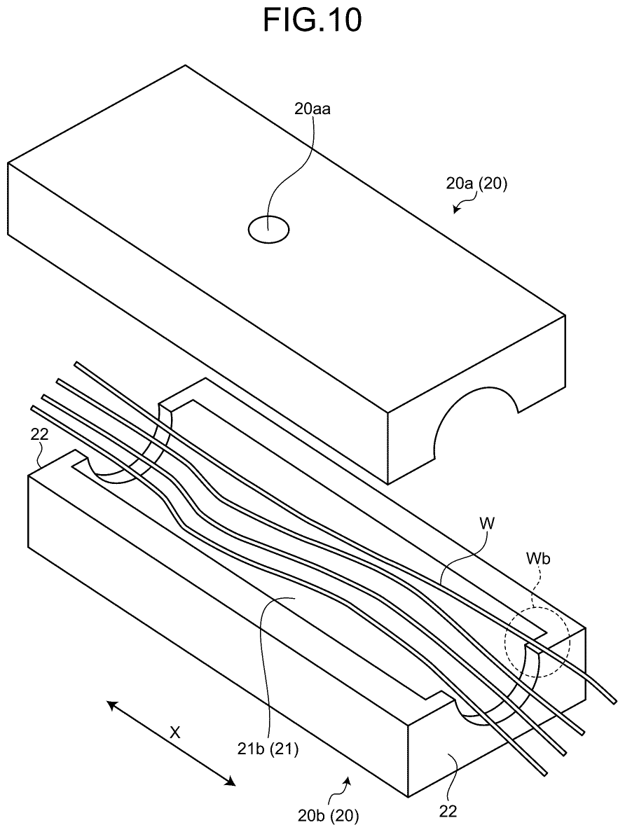

Next, a method for manufacturing the wire harness WH according to the second embodiment will be described. FIG. 8 is a schematic view illustrating a state in which winding tapes 10 are wound around a plurality of wiring members W in the second embodiment. When manufacturing a wire harness WH according to the second embodiment, first, winding tapes 10 are wound around the plurality of wiring members W at positions of two places spaced apart from each other in the extending direction X in the plurality of wiring members W as illustrated in FIG. 8. The winding tapes 10 disposed at the two portions are arranged in such a manner that an interval between the ends of the winding tapes 10 on sides facing the opposite winding tapes 10 is narrower than the length of the molded member 1, and an interval between the ends of the winding tapes 10 on sides opposite to the sides on which the opposite winding tapes 10 are located is wider than the length of the molded member 1. The wiring members W can be maintained in a state where the plurality of wiring members W are bundled by the winding tapes 10 by winding the winding tapes 10 around two positions of portions in a state where the plurality of wiring members W are bundled as described above.

FIG. 9 is an explanatory view illustrating a state in which the wiring members W illustrated in FIG. 8 are disposed in the mold 20. After the winding tapes 10 are wound around the wiring members W in a state where the plurality of wiring members W are bundled, the wiring members W are disposed in the mold 20 for forming a molded member 1. For example, as illustrated in FIG. 9, the wiring members W are first disposed in the lower mold 20b of the mold 20. That is, the wiring members W are disposed inside the second molding portion 21b formed in the lower mold 20b.

At this time, the wiring members W are disposed in such a manner that each of the two winding tapes 10 wound around the wiring members W is positioned from the inside of the second molding portion 21b to the outside of the end 22 of the mold 20. That is, the wiring members W are disposed to have a positional relationship with the lower mold 20b such that each of the two winding tapes 10 sticks out of the inside of the second molding portion 21b toward the outside of the end 22 of the mold 20.

After the wiring members W are disposed in the lower mold 20b, the upper mold 20a is laid on the lower mold 20b, and a melted resin material is injected into the molding portion 21 in a state where the wiring members W pass inside the first molding portion 21a of the upper mold 20a and the second molding portion 21b of the lower mold 20b. That is, in a state where the upper mold 20a and the lower mold 20b are laid on each other, a nozzle 31 (see FIG. 4) of an injection device 30 (see FIG. 4) is inserted into an insertion hole 20aa formed in the upper mold 20a, and the resin material is injected from the injection device 30. As a result, the resin material is injected into the molding portion 21 formed in the mold 20, and the molding portion 21 is filled with the resin material.

Since the resin material filled in the molding portion 21 is cooled and hardened over time, the hardened resin material is formed as a molded member 1 that covers the wiring members W. After the resin material in the molding portion 21 is hardened and the resin material is formed as the molded member 1, the upper mold 20a and the lower mold 20b are separated from each other to take out the molded member 1 formed by the mold 20.

At this time, the molded member 1 is formed in a state where each of the two winding tapes 10 wound around the wiring members W is positioned from the inside of the second molding portion 21b to the outside of the end 22 of the mold 20. Therefore, in the molded member 1 after being formed, each of the two winding tapes 10 is exposed outward in the extending direction X of the wiring members W from the inside of the molded member 1, and is disposed to include the position of the end 5 of the molded member 1 in the extending direction X of the wiring members W.

In the second embodiment, at the time of forming a molded member 1 using the mold 20, since the molding is performed in a state where the wiring members W bundled by the winding tapes 10 pass inside the molding portion 21 as described above, the molding is performed in a state where the plurality of wiring members W passing inside the molding portion 21 are not loose, similarly to the molding performed in the first embodiment. Furthermore, in the second embodiment, since the winding tapes 10 are disposed to include the positions of the ends 5 of the molded member 1 in the extending direction X of the wiring members W, it is possible to suppress the wiring members W from being caught by the mold 20 while forming the molded member 1.

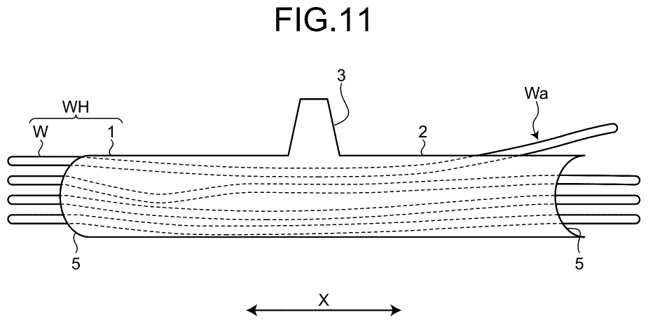

FIG. 10 is an explanatory view illustrating a state in which a plurality of wiring members W are disposed in the mold 20 without winding a winding tape 10 around the wiring members W. FIG. 11 is a schematic view of a wire harness WH with a molded member 1 formed without winding a winding tape 10 around a plurality of wiring members W. In a case where the molded member 1 is formed without winding the winding tape 10 around the wiring members W, when the wiring members W are disposed in the mold 20, some of the plurality of wiring members W may stick out of the molding portion 21 of the mold 20. That is, when the wiring members W are disposed inside the second molding portion 21b formed in the lower mold 20b without winding the winding tape 10 around the wiring members W, the plurality of wiring members W around which no winding tape 10 is wound are likely to be loose. Therefore, when the wiring members W are disposed inside the second molding portion 21b without winding the winding tape 10 around the wiring members W, there is a possibility that some of the loose wiring members W may stick out of the second molding portion 21b, for example, like a sandwiched portion Wb illustrated in FIG. 10.

Since the upper mold 20a and the lower mold 20b are laid on each other at the time of forming a molded member 1, when the upper mold 20a and the lower mold 20b are laid on each other in a state where some of the wiring members W stick out of the second molding portion 21b, the stick-out portion of the wiring member W is sandwiched between the upper mold 20a and the lower mold 20b. That is, when the wiring members W are disposed inside the second molding portion 21b formed in the lower mold 20b, the sandwiched portion Wb of the wiring member W sticking out of the second molding portion 21b is sandwiched at a portion other than the molding portion 21 between the upper mold 20a and the lower mold 20b when the upper mold 20a and the lower mold 20b are laid on each other.

When the molding portion 21 is filled with a melted resin material in a state where the sandwiched portion Wb of the wiring member W is sandwiched at a portion other than the molding portion 21 between the upper mold 20a and the lower mold 20b, the sandwiched portion Wb of the wiring member W is located outside the resin material. Therefore, when the resin material filled in the molding portion 21 is hardened, the resin material is hardened in a state where the sandwiched portion Wb of the wiring member W sticks out of the resin material. Therefore, in a case where the molded member 1 is formed by hardening the resin material in a state where the sandwiched portion Wb of the wiring member W protrudes from the resin material, the sandwiched portion Wb is a stick-out portion Wa sticking out of the molded member 1 in the wiring member W as illustrated in FIG. 11.

That is, the sandwiched portion Wb of the wiring member W does not come out of the molded member 1 from the position of the end 5 of the molded member 1, but comes out of the molded member 1 from the position of the outer surface 2 of the molded member 1. In this case, the molded member 1 cannot protect the stick-out portion Wa of the wiring member W that sticks out of the molded member 1.

On the other hand, in the wire harness WH according to the second embodiment, the winding tape 10 wound around the plurality of wiring members W is disposed to include the position of the end 5 of the molded member 1 in the extending direction X of the wiring members W. Therefore, when the plurality of wiring members W is disposed in the molding portion 21 of the mold 20, the wiring members W can be prevented from coming loose, and thus, it is possible to suppress some of the loose wiring members W from sticking out of the molding portion 21 and being sandwiched at a portion other than the molding portion 21 between the upper mold 20a and the lower mold 20b.

That is, by disposing the winding tapes 10 at positions including the positions of both ends 5 of the molded member 1 in the extending direction X of the wiring members W, the entire portions of the wiring members W disposed inside the molded member 1 can be maintained in a bundled state by the two winding tapes 10. As a result, at the time of attaching the molded member 1 for covering the plurality of wiring members W to the wiring members W by molding a resin material through injection molding, it is possible to attach the molded member 1 to the wiring members W in a state where the plurality of wiring members W disposed inside the molded member 1 are bundled.

Therefore, when the molded member 1 is formed using the mold 20, it is possible to suppress some of the wiring members W from sticking out of the molding portion 21 of the mold 20, and it is possible to suppress some of the wiring members W from being sandwiched at portions other than the molding portion 21 between the upper mold 20a and the lower mold 20b. As a result, it is possible to suppress the wiring members W from being loose when the molded member 1 is attached to the wiring members W, and it is possible to suppress some of the loose wiring members W from sticking out of the molded member 1 after being formed.

### Modification

Although the protrusion 3, which is a gate portion when the molded member 1 is formed, is formed in the molded member 1 after being formed in the first and second embodiments described above, the protrusion 3 may be removed after the molded member 1 is formed. Since the protrusion 3 is not involved in the protection of the wiring members W by the molded member 1, it does not matter whether the protrusion 3 is present in the molded member 1 after being formed.

Although the winding tapes 10 wound around the wiring members W are disposed to include the positions of both ends 5 of the molded member 1 in the extending direction X of the wiring members W in the second embodiment described above, the winding tapes 10 may not be disposed at the positions of both ends 5 of the molded member 1. For example, the winding tape 10 wound around the wiring members W may be disposed at the position of the one end 5 of the molded member 1 and may not be disposed at the position of the other end 5 of the molded member 1. The winding tape 10 wound around the wiring members W is preferably disposed to include the position of the end 5 of the molded member 1 on at least the side where the wiring members W are likely to stick out of the molding portion 21 of the mold 20 and the wiring members W are likely to be sandwiched at a portion other than the molding portion 21 of the mold 20, depending on the shapes and the like of the molded member 1 and the mold 20.

In addition, although the molded member 1 is formed in a substantially columnar shape in which the axial direction is a direction along the extending direction X of the wiring members W in the first and second embodiments described above, the molded member 1 may be formed in another shape. The molded member 1 may be formed in, for example, a substantially prismatic shape, or may be formed in a so-called substantially truncated cone shape in which one end 5 and the other end 5 of the molded member 1 are different in size. The shape of the molded member 1 is not limited as long as the molded member 1 is capable of partially protecting the necessary portions of the wiring members W.

In the wire harness and the method for manufacturing the wire harness according to the present embodiment, the plurality of wiring members disposed inside the molded member, which is an exterior member, is disposed inside the exterior member in a state where the winding tape is wound around the plurality of wiring members and the plurality of wiring members are bundled by the winding tape. Therefore, at the time of attaching the exterior member for covering the plurality of wiring members to the wiring members by forming the molded member using the mold, it is possible to attach the molded member to the wiring members while maintaining the plurality of wiring members in the bundled state. As a result, it is possible to suppress the wiring members from being loose when the exterior member is attached to the wiring members, and it is possible to suppress the wiring members from sticking out of the exterior member.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wire harness comprising:
a plurality of wiring members having conductivity;
a molded member provided integrally with the plurality of wiring members by covering the plurality of wiring members; and
a winding tape bundling the plurality of wiring members disposed inside the molded member.

2. The wire harness according to claim 1, wherein
the winding tape is disposed to include a position that is the same as a position where a gate portion of the molded member is formed in an extending direction of the wiring members.

3. The wire harness according to claim 1, wherein
the winding tape is disposed to include a position of an end of the molded member in an extending direction of the wiring members.

4. A method for manufacturing a wire harness, comprising:
bundling a plurality of wiring members having conductivity and winding a winding tape around the plurality of wiring members; and
providing a molded member by injection molding around the plurality of wiring members around which the winding tape is wound.
